(19) United States
(12) Patent Application Publication
(10) Pub. No.: US 2006/0270503 A1
(43) Pub. Date: Nov. 30, 2006

(54) Cooling system for continuous variable transmission of vehicle

(76) Inventors: Takanori Suzuki, Shizuoka (JP); Kazuhiko Izumi, Shizuoka (JP); Kyousuke Tanaka, Newnan, GA (US)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(21) Appl. No.: 11/139,196

(22) Filed: May 27, 2005

(51) Int. Cl. B62J 13/00; F16H 57/04

(52) U.S. Cl. 474/144; 474/93

(57) ABSTRACT

A vehicle includes a frame assembly, an engine mounted on the frame assembly, and a continuous variable transmission connected to the engine. The continuous variable transmission includes a housing including an air intake duct and an exhaust duct, a drive shaft disposed in the housing, a drive pulley including at least one sheave disposed on the drive shaft, a driven shaft disposed in the housing and spaced from the drive shaft, a driven pulley including at least one sheave disposed on the driven shaft, and a fan disposed on the driven shaft. The fan is disposed between an inner surface of the housing and the driven pulley so as to be spaced from the driven pulley. The air intake duct defines an opening in the housing for providing air from outside the housing into the housing, and the air intake duct is axially aligned with the driven shaft and the fan disposed thereon, such that the air flows directly into the fan and is directed to the driven pulley.

### BACKGROUND OF THE INVENTION

1. Field of the Invention

The present invention relates to a continuously variable transmission (CVT) cooling system for a vehicle, such as an All-Terrain Vehicle (ATV), Side-by-Side Vehicle (SSV) or other off-road vehicle. More particularly, the present invention relates to a CVT cooling system having an improved cooling system layout and fan configuration for a vehicle such as an ATV, SSV or other off-road vehicle.

2. Description of the Related Art

ATVs, SSVs and other off-road vehicles are commonly used on a variety of harsh terrain including sand, dirt, and in shallow water. These vehicles include CVTs which must be cooled during operation. Accordingly, cooling systems are provided in the vehicles to cool the CVTs during operation.

However, conventional cooling systems have been unable to provide sufficient cooling of the CVT, especially in SSVs, which produce a much larger load than that produced by conventional ATVs. As the load increases, the heat generated in the CVT is greatly increased. The increased heat deteriorates the reliability of the V-belt used in the CVT. Thus, conventional cooling systems are not suitable for use in SSVs.

A conventional CVT cooling system used in an ATV is disclosed in U.S. Pat. No. 4,697,665. As seen in FIG. 2 of U.S. Pat. No. 4,697,665, centrifugal-type fans 26 are integrally formed with a sheave 23 of a drive pulley 21 and a sheave 32 of a driven pulley 30. As seen in FIG. 2, the centrifugal-type fan 26 includes blades that are disposed on a plate-like member. The centrifugal-type fan 26 produces airflow that extends outwardly from the center of the fan 26. Since there no openings in the plate-like member of the centrifugal-type fan 26, no air passes through the centrifugal-type fan 26. Centrifugal-type fans do not efficiently produce airflow, and thus, the cooling system of U.S. Pat. No. 4,697,665 is insufficient to effectively cool the CVT. Due to the structure of the centrifugal-type fans 26 and the sheaves 23 and 32, axial fans, which are far more efficient, cannot be used in the cooling system of U.S. Pat. No. 4,697,665. The air intake 40 of U.S. Pat. No. 4,697,665 is located adjacent to the drive pulley 21 and the exhaust is located adjacent to the driven pulley 30.

Another conventional CVT cooling system is disclosed in Japanese Unexamined Patent Application Publication No. 61-278661. As seen in FIG. 1 of JP 61-278661, a centrifugal-type fan 23 is provided on a driven shaft 7. The centrifugal-type fan 23 is installed on an outer surface of the cover 4 and in a fan casing 20. A ventilation apparatus 26 is provided to lead to a cooled-air outlet port 25 along the outer surface of the cover 4 in a V-belt chamber portion 14. The ventilation apparatus 26 directs the airflow from the centrifugal-type fan 23 to the cylinder 18 so as to cool the cylinder 18 of the CVT. However, since the centrifugal-type fan 23 is disposed outside of the CVT, the cooling system is insufficient to effectively cool a CVT of an off-road vehicle.

FIGS. 7-10 of the present application illustrate another conventional CVT cooling system used in an off-road vehicle 100. As seen in FIGS. 8 and 10 of the present application, a drive pulley 102 includes a centrifugal-type fan 104 that is integrally formed with a sheave 106 of the drive pulley 102. The centrifugal-type fan 104 directs the airflow towards the driven pulley 200. The drive pulley 102 and the driven pulley 200 are arranged to accommodate a V-belt thereon.

As seen in FIGS. 7-10, the air intake 300 is disposed adjacent to the drive pulley 102 and the exhaust 302 is disposed adjacent to the driven pulley 200. As seen in FIGS. 9 and 10, the air intake duct 300 is disposed at a rear portion of the CVT 99 and the exhaust duct 302 is disposed at a front portion of the CVT 99 that is closer to the front of the vehicle 100 than the rear portion of the CVT 99.

Similar to the cooling system of U.S. Pat. No. 4,697,665, the centrifugal-type fan 104 is insufficient to effectively cool the CVT 99.

### SUMMARY OF THE INVENTION

To overcome the problems described above, preferred embodiments of the present invention provide a cooling system for a CVT of an off-road vehicle which more effectively cools the CVT in an efficient manner while being compact and enabling a larger passenger compartment.

According to a preferred embodiment of the present invention, A continuous variable transmission includes a housing including an air intake duct and an exhaust duct, a drive shaft disposed in the housing, a drive pulley including at least one sheave disposed on the drive shaft, a driven shaft disposed in the housing and spaced from the drive shaft, a driven pulley including at least one sheave disposed on the driven shaft; and a fan disposed on the driven shaft, the fan being disposed between an inner surface of the housing and the driven pulley so as to be spaced from the driven pulley, wherein the air intake duct defines an opening in the housing for providing air from outside the housing into the housing, and the air intake duct is axially aligned with the driven shaft and the fan disposed thereon, such that the air flows directly into the fan and is directed to the driven pulley.

It is preferred that the fan is an axial-type fan including a hub and a plurality of blades extending from the hub such that the plurality of blades are spaced apart from each other. The hub of the fan preferably includes a central hole through which the driven shaft extends and a plurality of fastening holes for fastening the fan to the drive shaft.

It is also preferred that each of the plurality of blades of the fan has a width that increases as the distance from the hub increases, and that an angle of inclination of each of the plurality of blades decreases as the distance from the hub increases.

The housing preferably includes a fan shroud that is disposed around the air intake duct and that surrounds the fan, and it is also preferred that the fan shroud is integral with the housing.

The air intake duct is preferably disposed on a front side portion of the housing and the exhaust duct is disposed on a rear portion of the housing.

The driven shaft and the drive shaft are preferably configured such that the rotational speed of the driven shaft is greater than the rotational speed on the drive shaft.

In another preferred embodiment of the present invention, a vehicle includes a frame assembly, an engine attached to the frame assembly, and a continuous variable transmission connected to the engine, the continuous variable transmission has the elements and arrangement according to the preferred embodiment of the present invention described above.

These and other features, elements, characteristics and advantages of the present invention will become more apparent from the following detailed description of preferred embodiments of the present invention with reference to the attached drawings.

### BRIEF DESCRIPTION OF THE DRAWINGS

FIG. 1 is a top plan view of a vehicle having a CVT and a cooling system according to a preferred embodiment of the present invention;

FIG. 2 is a side view of the vehicle of FIG. 1;

FIGS. 3A-3D are views of the fan used in the cooling system according to a preferred embodiment of the present invention;

FIG. 4 is a side view of the fan shown in FIGS. 3A-3D;

FIG. 5 is a side view of the exterior of CVT and the cooling system according to a preferred embodiment of the present invention;

FIG. 6 is a top view of the interior of the CVT and the cooling system according to a preferred embodiment of the present invention;

FIG. 7 is a side view of the exterior of a conventional CVT and cooling system therefor;

FIG. 8 is a side view of the interior of the conventional CVT and cooling system shown in FIG. 7;

FIG. 9 is a top plan view of a conventional off-road vehicle including a conventional CVT and cooling system; and

FIG. 10 is a side view of the conventional off-road vehicle having the conventional CVT and cooling system shown in FIG. 9.

### DETAILED DESCRIPTION OF PREFERRED EMBODIMENTS

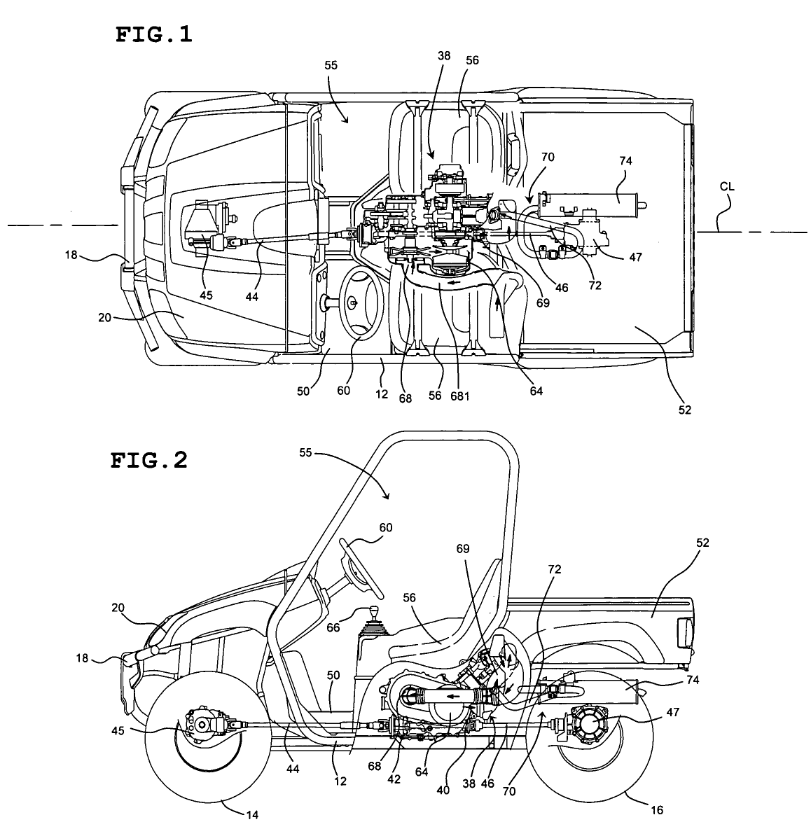

With reference to FIGS. 1 and 2, an off-road vehicle, which is generally indicated by the reference numeral 10, will be described, however, the present invention is not limited thereto and relates to any type of vehicle in which a CVT is used. The vehicle 10 is preferably arranged and configured in accordance with preferred embodiments of the present invention. More particularly, the vehicle 10 preferably includes an exhaust system, which will be described below, that is arranged and configured in accordance with preferred embodiments of the present invention.

While the present invention will be described in the context of the illustrated vehicle 10, which is preferably an SSV, it should be understood that the present invention may also be applied to various types of vehicles. For instance, although the illustrated vehicle 10 includes four wheels, the present invention could be used on motor vehicles having two wheels, three wheels or more than four wheels. In addition, the present invention may also be used in vehicles having runners and tracks or other drive arrangements. Furthermore, although the illustrated vehicle 10 includes two seats, the present invention may be used on motor vehicles having one seat, or three or more seats.

The illustrated vehicle 10 includes a frame assembly 12 that is supported by a plurality of wheels. In the illustrated arrangement, the frame assembly 12 is supported by a pair of front wheels 14 and a pair of rear wheels 16. Alternatively, the vehicle 10 could be carried by a single front wheel and a pair of rear wheels, a pair of front wheels and single rear wheel, or any number of front or rear wheels. Furthermore, as discussed above, the present invention may also be used with vehicles that utilize driving track arrangements and forward runners, for example, instead of wheels.

The frame assembly 12 is preferably a welded type of frame assembly, as is known to those of ordinary skill in the art. However, any suitable type of frame assembly may be used. While not illustrated, the presently preferred type of frame includes a left side assembly and right side assembly. The left side assembly and the right side assembly are interconnected with crossing members. Because these assemblies are well known to those of ordinary skill in the art, further description of the frame assembly 12 is deemed unnecessary to understand the present invention.

A forward portion of the illustrated frame assembly 12 includes a front bumper 18. With reference now to FIGS. 1 and 2, the front bumper 18 preferably extends upwardly and forwardly of a lower portion of the illustrated frame assembly 12. In this manner, the front bumper 18 wraps around a forward portion of a front fender assembly 20. The front bumper 18 may be integrally formed with the frame assembly 12 or may be a separate add-on component, as will be recognized by those of ordinary skill in the art.

The illustrated front wheels 14 are rotatably supported by a conventional front suspension system (not shown). Because the front suspension system is well known to those of ordinary skill in the art, further description of the arrangement is deemed unnecessary.

The rear wheels 16 preferably rotate about a common axle and a rear suspension system (not shown). However, independently suspended rear wheels may also be used. Because the rear suspension system is well known to those of ordinary skill in the art, further description of the arrangement is deemed unnecessary.

The illustrated frame assembly 12 provides a platform upon which a variety of other components are mounted. For instance, the hollow central portion of the illustrated frame assembly 12 defines an engine compartment 38. The engine compartment 38 is defined between the left portion and the right portion of the frame assembly 12 and is disposed between the front wheels 14 and the rear wheels 16. This location provides a low center of gravity for the vehicle by mounting a centrally located engine 40 within the engine compartment 38. The engine 40 may have any suitable construction and may be arranged either transversely or longitudinally within the engine compartment 38. In other words, a crankshaft (not shown) of the engine 40 may extend transverse to the direction of travel of the vehicle 10 or may extend along the same direction of travel of the vehicle.

A transfer case 42 is provided at a lower portion of the engine 40. A front drive shaft 44 extends between the transfer case 42 and a front differential gear box 45 to drive the front wheels 14. A rear drive shaft 46 extends between the transfer case 42 and a rear differential gear box 47 to drive the rear wheels 16. In the present preferred embodiment, the transfer case can be set to drive only the rear wheels 16 or drive both the front wheels 14 and the rear wheels 16. However, other arrangements are within the scope of the present invention. For example, only a front drive shaft and a front differential gear box may be provided, or only a rear drive shaft and a rear differential gear box may be provided. Because the structure of the transfer case 42, the front drive shaft 44, the front differential gear box 45, the rear drive shaft 46 and the rear differential gear box 47 are well known to those of ordinary skill in the art, further description of the arrangement is deemed unnecessary.

In some applications, side panels may be provided to at least partially enclose the engine compartment 38. The side panels preferably extend downward from a portion of the seats 56 toward an exterior surface of the engine 40 and an associated CVT 64 including an air intake duct 68 and an exhaust duct 69. As seen in FIG. 1, in the present preferred embodiment, the engine 40 is preferably displaced to the right side of the centerline CL of the vehicle 10 so as to provide sufficient space for the CVT 64. However, the engine 40 may be disposed at any suitable location in the vehicle 10.

As indicated above, a front fender assembly 20 is preferably disposed above the front wheels 14. The front fender assembly 20 may include a single component or multiple components, and preferably extends around the front portion of the vehicle 10. The front fender assembly 20 is preferably made from a moldable resin material or a lightweight sheet metal, and is preferably mounted to the frame assembly in any suitable manner. The illustrated arrangement uses threaded fasteners to removably attach the front fender assembly 20 to the frame assembly 12.

In the illustrated arrangement, a carrier bed 52 is mounted to a rear portion of the frame assembly 12. Preferably, the carrier bed 52 is connected to the rear portion of the frame assembly 12 using threaded fasteners, or other mechanical fasteners, that can be removed from the top of the vehicle. The use of top mounted fasteners advantageously enables easy removal of the carrier bed 52 for maintenance.

Two seats 56 are preferably disposed above the engine 40. The seats 56 are arranged side-by-side so as to accommodate a driver and a passenger. Of course, the seats 56 may be arranged in any other suitable configuration and only one seat 56 or more than two seats 56 may be provided.

With continued reference to FIGS. 1 and 2, a fuel tank (not shown) is preferably disposed below the seats 56. The fuel tank is mounted in any suitable manner and can be made of any suitable material. Preferably, the fuel tank is made of molded resin materials. However, the fuel tank may also be made of a lightweight metal material.

A steering wheel assembly 60 is coupled to the front wheels 14 through a suitable steering arrangement, which is not shown.

The vehicle 10 also preferably includes a gear shifting arrangement. The gear shifting arrangement is preferably controlled by a gear shift lever 66. The gear shift lever 66 may be located anywhere that is proximate to the operator of the vehicle 10, such that the gear shift lever 66 can be easily actuated by the operator. In the present preferred embodiment of the present invention, the gear shift lever is preferably located between the seats 56. In some arrangements, the gear shift lever 66 operates a shifting mechanism for use when the vehicle is on the fly and in other arrangements the gear shift operator actuator 66 is used to control the gear shifting while the vehicle is at a standstill.

The illustrated vehicle 10 also includes a foot brake actuator (not shown) and an accelerator actuator (not shown). The foot brake actuator is pivotably attached to the frame assembly 12 through a suitable mounting bracket. When the foot brake actuator is depressed by the foot of an operator, the brakes are applied so as to slow the vehicle to a stop. In some arrangements, the foot brake actuator may operate a parking brake or may actuate all or fewer than all of the brakes associated with the wheels 14, 16. Preferably, the foot brake actuator extends upwardly through a hole defined within the footboard 50. In this arrangement, the majority of the foot brake actuator is disposed below the footboard 50 and out of the leg area of the vehicle 10.

As shown in FIGS. 1 and 2, the vehicle 10 also includes an exhaust system 70 for discharging exhaust gases produced in the engine 40 during combustion. The exhaust system includes an exhaust pipe 72 which extends from the engine 40 to the muffler 74. The exhaust pipe 72 may be configured in any suitable shape so as to effectively utilize the space between the engine 40 and the muffler 74. In the present preferred embodiment, the exhaust pipe 72 is configured so as to extend in a loop.

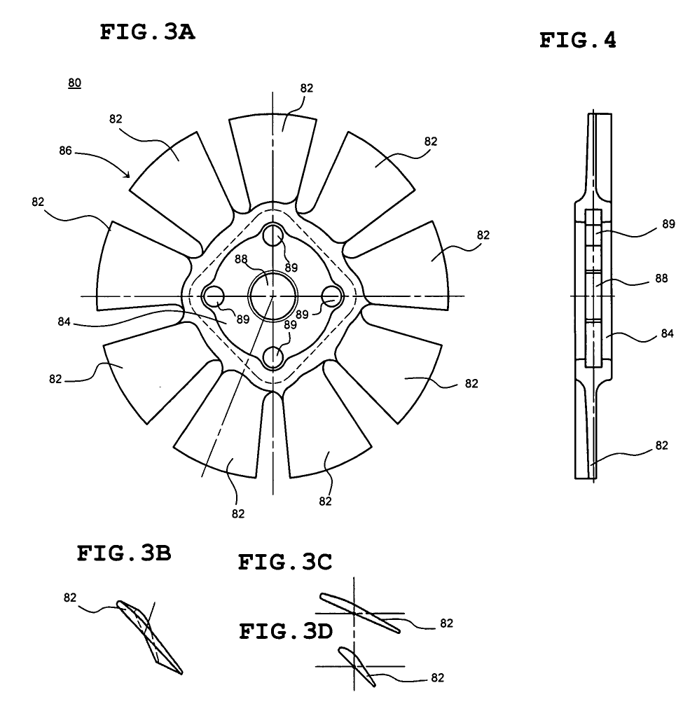

FIGS. 3A-3D show a fan 80 for use in the cooling system according to the present preferred embodiment of the present invention. As seen in FIG. 3A, the fan 80 is preferably an axial-type fan which includes a plurality of blades 82 extending outwardly from a central hub 84. Each of the plurality of blades 82 are arranged such that the blades 82 are spaced apart from each other with a space 86 therebetween. The fan 80 may include any suitable number of blades 82.

The hub 84 includes a central hole 88 through which a drive shaft 90 (see FIG. 6) extends, and a plurality of fastening holes 89 disposed around the central hole 88 for fastening the axial fan 80 to the drive shaft 90. Any suitable fastening elements may be used, such as screws, bolts, or rivets. In the present preferred embodiment, the hub includes four fastening holes 89. However, any suitable number of fastening holes 89 may be provided.

Each of the blades 82 has a profile as shown in FIGS. 3B, 3C and 3D. Particularly, the width of the blades 82 increases as the distance form the hub 84 increases, and the angle of inclination of the blades 82 decreases as the distance from the hub 84 increases. FIG. 3B shows an edge view of the blade 82. FIG. 3C shows a cross-sectional view of the blade 82 at an outer peripheral portion of the blade 82, and FIG. 3D shows a cross-sectional view of the blade 82 at a portion of the blade 82 disposed adjacent to the hub 84. The configuration and arrangement of the blades 82 is designed to pull air through the fan 80, to increase the speed of the airflow, and to maximize the amount of airflow through the fan 80.

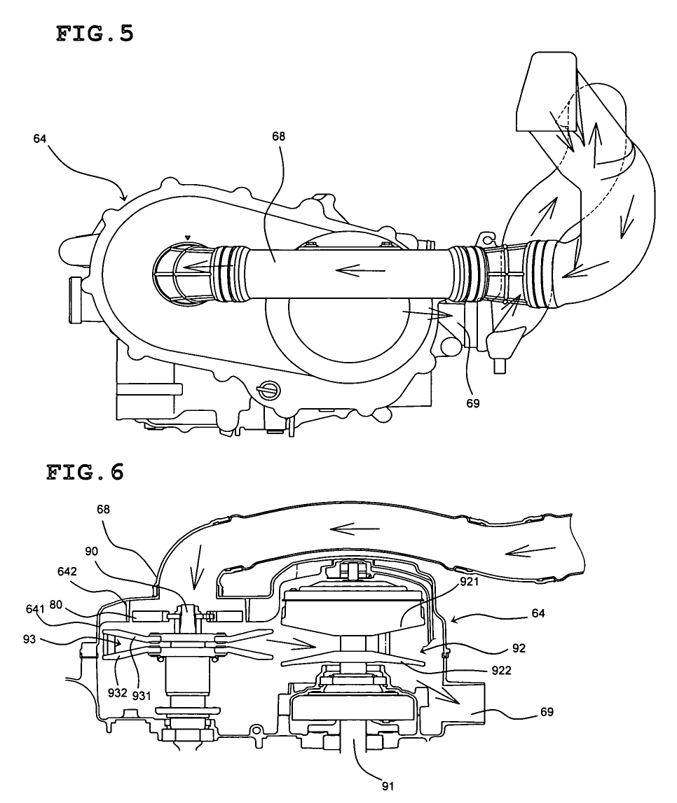

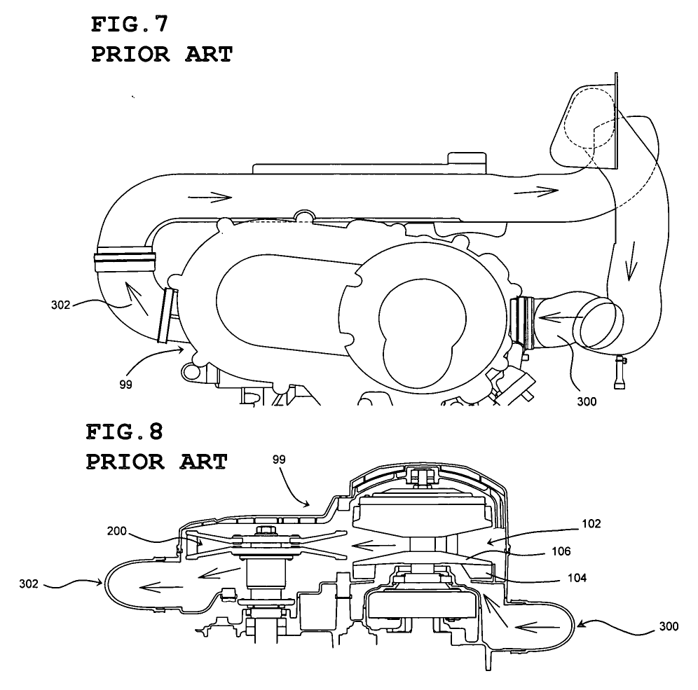

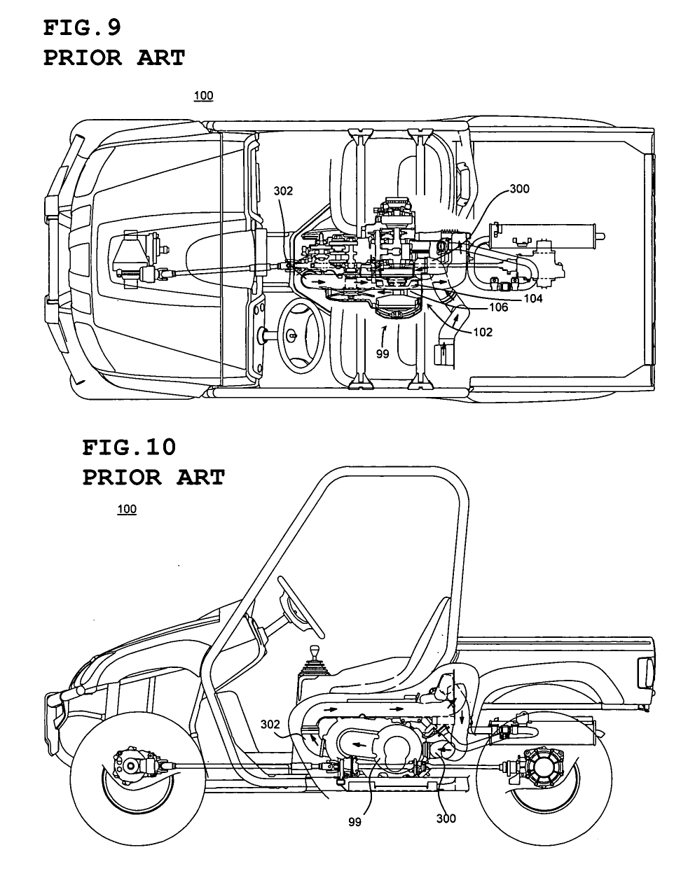

As shown in FIGS. 1, 2, 5 and 6, an air intake duct 68 for providing air to the CVT 64 is provided at a front portion of the CVT 64 and an exhaust duct 69 for discharging air from the CVT 64 is provided at a rear portion of the CVT 64. The air intake duct 68 is disposed closer to the front of the vehicle 10 than the exhaust duct 69.

As best seen in FIG. 6, a drive pulley 92 is disposed on a drive shaft 91 in a rear portion of the CVT 64 adjacent to the exhaust duct 69, and a driven pulley 93 is disposed on a driven shaft 90 in a front portion of the CVT 64 adjacent to the air intake duct 68. The drive pulley 92 includes a pair of sheaves 921 and 922 and the driven pulley 93 includes a pair of sheaves 931 and 932. The drive pulley 92 and the driven pulley 93 are arranged such that a V-belt (not shown) is disposed between the pair of sheaves 921 and 922 of the drive pulley 92 and between the pair of sheaves 931 and 932 of the driven pulley 93. The V-belt transfers the rotational force of the drive pulley 92 to the driven pulley 93. The drive pulley 92 and the driven pulley 93 are configured such that the rotational speed of the driven pulley 93 is greater than the rotational speed of the drive pulley 92.

The fan 80 is disposed on and fixed to the driven shaft 90 by any suitable fastening elements, such as, screws, bolts or rivets. The fan 80 is located between the air intake duct 68 and the driven pulley 93 so as to be spaced from the driven pulley 93. A fan shroud 642 is provided on an inner surface of the housing 641 of the CVT 64. The fan shroud 642 is arranged to surround the fan 80 and to direct the airflow of the air intake duct 68 to the fan 80. In the present preferred embodiment, the fan shroud 642 is preferably integrally formed with the housing 641. However, the fan shroud 642 may be a separate component that is attached to an inner surface of the housing 641.

The air intake duct 68 is preferably axially aligned with the driven shaft 90 and the fan 80 such that the air flows directly into the fan 80. Due to the arrangement of the air intake duct 68 and the fan shroud 642, the amount of air flowing into the fan 80 and the speed of the airflow is greatly increased, which produces greatly improved cooling.

As seen in FIG. 1, the air intake duct 68 is disposed on a front side portion of the CVT 64, and an intake pipe 681 extends along a side portion of the CVT 64. This arrangement provides a compact layout which utilizes unused space in the engine compartment 38. This arrangement enables the size of passenger compartment 55 to be increased.

As compared to the centrifugal-type fans used in the conventional cooling systems described above, the fan 80 according to the preferred embodiment is much more efficient and produces greatly improved airflow and cooling. In addition, since the driven shaft 90 rotates at a higher rotational speed than the drive shaft 91, the amount and speed of the airflow is further improved.

As illustrated by the arrows shown in FIG. 6, air enters the front portion of the CVT 64 through the air intake 68, passes through the fan 80 to increase the airflow and speed of the airflow, flows over the driven pulley 93 and the drive pulley 92 and is discharged at the rear portion of the CVT 64 through the exhaust duct 69.

Thus, the cooling system according to the present preferred embodiment of the present invention provides greatly improved cooling of the components of the CVT.

While the present invention has been described with respect to the preferred embodiment, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A continuous variable transmission comprising:
a housing including an air intake duct and an exhaust duct;
a drive shaft disposed in the housing;
a drive pulley including at least one sheave disposed on the drive shaft;
a driven shaft disposed in the housing and spaced from the drive shaft;
a driven pulley including at least one sheave disposed on the driven shaft; and
a fan disposed on the driven shaft, the fan being disposed between an inner surface of the housing and the driven pulley so as to be spaced from the driven pulley; wherein
the air intake duct defines an opening in the housing for providing air from outside the housing into the housing; and
the air intake duct is axially aligned with the driven shaft and the fan disposed thereon, such that the air flows directly into the fan and is directed to the driven pulley.

2. The continuous variable transmission according to claim 1, wherein the fan is an axial-type fan including a hub and a plurality of blades extending from the hub such that the plurality of blades are spaced apart from each other.

3. The continuous variable transmission according to claim 2, wherein each of the plurality of blades has a width that increases as the distance from the hub increases.

4. The continuous variable transmission according to claim 2, wherein an angle of inclination of each of the plurality of blades decreases as the distance from the hub increases.

5. The continuous variable transmission according to claim 1, wherein the housing includes a fan shroud that is disposed around the air intake duct and that surrounds the fan.

6. The continuous variable transmission according to claim 5, wherein said fan shroud is integral with the housing.

7. The continuous variable transmission according to claim 1, wherein the air intake duct is disposed on a front side portion of the housing and the exhaust duct is disposed on a rear portion of the housing.

8. The continuous variable transmission according to claim 1, wherein the driven shaft and the drive shaft are configured such that the rotational speed of the driven shaft is greater than the rotational speed on the drive shaft.

9. The continuous variable transmission according to claim 2, wherein the hub of the fan includes a central hole through which the driven shaft extends and a plurality of fastening holes for fastening the fan to the drive shaft.

10. A vehicle comprising:
a frame assembly;
an engine mounted on the frame assembly;
a continuous variable transmission connected to the engine including:
a housing including an air intake duct and an exhaust duct;
a drive shaft disposed in the housing;
a drive pulley including at least one sheave disposed on the drive shaft;
a driven shaft disposed in the housing and spaced from the drive shaft;
a driven pulley including at least one sheave disposed on the driven shaft; and
a fan disposed on the driven shaft, the fan being disposed between an inner surface of the housing and the driven pulley so as to be spaced from the driven pulley; wherein
the air intake duct defines an opening in the housing for providing air from outside the housing into the housing; and
the air intake duct is axially aligned with the driven shaft and the fan disposed thereon, such that the air flows directly into the fan and is directed to the driven pulley.

11. The vehicle according to claim 10, wherein the fan is an axial-type fan including a hub and a plurality of blades extending from the hub such that the plurality of blades are spaced apart from each other.

12. The vehicle according to claim 11, wherein each of the plurality of blades has a width that increases as the distance from the hub increases.

13. The vehicle according to claim 11, wherein an angle of inclination of each of the plurality of blades decreases as the distance from the hub increases.

14. The vehicle according to claim 10, wherein the housing includes a fan shroud that is disposed around the air intake duct and that surrounds the fan.

15. The vehicle according to claim 14, wherein said fan shroud is integral with the housing.

16. The vehicle according to claim 10, wherein the air intake duct is disposed on a front side portion of the housing and the exhaust duct is disposed on a rear portion of the housing.

17. The vehicle according to claim 10, wherein the driven shaft and the drive shaft are configured such that the rotational speed of the driven shaft is greater than the rotational speed on the drive shaft.

18. The vehicle according to claim 11, wherein the hub of the fan includes a central hole through which the driven shaft extends and a plurality of fastening holes for fastening the fan to the drive shaft.

19. The vehicle according to claim 10, wherein the driven pulley is disposed closer to a front portion of the off-road vehicle than the drive pulley.

20. The vehicle according to claim 10, wherein the off-road vehicle is a side-by-side vehicle.
